(19) United States
(12) Patent Application Publication
(10) Pub. No.: US 2014/0269934 A1
(43) Pub. Date: Sep. 18, 2014

(54) VIDEO CODING SYSTEM WITH MULTIPLE SCALABILITY AND METHOD OF OPERATION THEREOF

(71) Applicant: SONY CORPORATION, Tokyo (JP)

(72) Inventors: Munsi Haque, San Jose, CA (US); Teruhiko Suzuki, Yokohama (JP); Ali Tabatabai, Cupertino, CA (US)

(73) Assignee: SONY CORPORATION, Tokyo (JP)

(21) Appl. No.: 13/843,647

(22) Filed: Mar. 15, 2013

(51) Int. Cl. H04N 19/39

(52) U.S. Cl. CPC H04N 19/0046
USPC 375/240.25

(57) ABSTRACT

A method of operation of a video coding system includes: receiving a video bitstream; extracting a video syntax from the video bitstream; extracting a high efficiency video coding (HEVC) extension flag from the video syntax; extracting a video usability information (VUI) extension layer structure from the video syntax based on the HEVC extension flag; extracting an extension layer from the video bitstream based on the VUI extension layer structure; and forming a video stream based on the extension layer for displaying on a device.

### TECHNICAL FIELD

The present invention relates generally to video systems, and more particularly to a system for video coding with multiple scalability.

### BACKGROUND ART

The deployment of high quality video to smart phones, high definition televisions, automotive information systems, and other video devices with screens has grown tremendously in recent years. The wide variety of information devices supporting video content requires multiple types of video content to be provided to devices with different size, quality, and connectivity capabilities.

Video has evolved from two dimensional single view video to multiview video with high-resolution three-dimensional imagery. In order to make the transfer of video more efficient, different video coding and compression schemes have tried to get the best picture from the least amount of data. The Moving Pictures Experts Group (MPEG) developed standards to allow good video quality based on a standardized data sequence and algorithm. The H.264 (MPEG4 Part 10)/Advanced Video Coding design was an improvement in coding efficiency typically by a factor of two over the prior MPEG-2 format. The quality of the video is dependent upon the manipulation and compression of the data in the video. The video can be modified to accommodate the varying bandwidths used to send the video to the display devices with different resolutions and feature sets. However, distributing larger, higher quality video, or more complex video functionality requires additional bandwidth and improved video compression.

Thus, a need still remains for a video coding system that can deliver good picture quality and features across a wide range of device with different sizes, resolutions, and connectivity. In view of the increasing demand for providing video on the growing spectrum of intelligent devices, it is increasingly critical that answers be found to these problems. In view of the ever-increasing commercial competitive pressures, along with growing consumer expectations and the diminishing opportunities for meaningful product differentiation in the marketplace, it is critical that answers be found for these problems. Additionally, the need to save costs, improve efficiencies and performance, and meet competitive pressures, adds an even greater urgency to the critical necessity for finding answers to these problems.

Solutions to these problems have long been sought but prior developments have not taught or suggested any solutions and, thus, solutions to these problems have long eluded those skilled in the art.

### DISCLOSURE OF THE INVENTION

The present invention provides a method of operation of a video coding system including: receiving a video bitstream; extracting a video syntax from the video bitstream; extracting a high efficiency video coding (HEVC) extension flag from the video syntax; extracting a video usability information (VUI) extension layer structure from the video syntax based on the HEVC extension flag; extracting an extension layer from the video bitstream based on the VUI extension layer structure; and forming a video stream based on the extension layer for displaying on a device.

The present invention provides a video coding system, including: a receive module for receiving a video bitstream as a serial bitstream; a get syntax module, coupled to the receive module, for extracting a video syntax from the video bitstream, extracting a high efficiency video coding (HEVC) extension flag from the video syntax, and extracting a video usability information (VUI) extension layer structure from the video syntax based on the HEVC extension flag; a decode module, coupled to the get syntax module, for extracting an extension layer from the video bitstream based on the VUI extension layer structure; and a display module, coupled to the decode module, forming a video stream based on the extension layer for displaying on a device.

Certain embodiments of the invention have other aspects in addition to or in place of those mentioned above. The aspects will become apparent to those skilled in the art from a reading of the following detailed description when taken with reference to the accompanying drawings.

### BRIEF DESCRIPTION OF THE DRAWINGS

FIG. 1 is a block diagram of a video coding system in an embodiment of the present invention.

FIG. 2 is an example of the video bitstream.

FIG. 3 is an example of a HRD syntax.

FIG. 4 is an example of a High Efficiency Video Coding (HEVC) Video Usability Information (VUI) syntax.

FIG. 5 is an example of a VUI first extension syntax.

FIG. 6 is an example of a VUI second extension syntax.

FIG. 7 is an example of a scalability type table.

FIG. 8 is an example of a dimension type table.

FIG. 9 is an example of a sub-scalability table.

FIG. 10 is an example of a scalability type mapping table.

FIG. 11 is an example of a coding type table.

FIG. 12 is a functional block diagram of the video coding system.

FIG. 13 is a control flow of the video coding system.

FIG. 14 is a flow chart of a method of operation of the video coding system in a further embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that process or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

Likewise, the drawings showing embodiments of the system are semi-diagrammatic and not to scale and, particularly, some of the dimensions are for the clarity of presentation and are shown greatly exaggerated in the drawing FIGs. Where multiple embodiments are disclosed and described, having some features in common, for clarity and ease of illustration, description, and comprehension thereof, similar and like features one to another will ordinarily be described with like reference numerals.

The term “syntax” means the set of elements describing a data structure. The term “module” referred to herein can include software, hardware, or a combination thereof in the present invention in accordance with the context used.

Referring now to FIG. 1, therein is shown a block diagram of a video coding system 100 in an embodiment of the present invention. A video encoder 103 can receive a video content 108 and send a video bitstream 110 to a video decoder 105 for decoding and display on a display interface 120.

The video encoder 103 can be implemented in a first device 102, a second device 104, or a combination thereof. The video decoder 105 can be implemented in the first device 102, the second device 104, or a combination thereof.

The video encoder 103 can receive and encode the video content 108. The video encoder 103 is a unit for encoding the video content 108 into a different form. The video content 108 is defined as a digital representation of a scene of objects. For example, the video content 108 can be the digital output of one or more digital video cameras.

Encoding is defined as computationally modifying the video content 108 to a different form. For example, encoding can compress the video content 108 into the video bitstream 110 to reduce the amount of data needed to transmit the video bitstream 110.

In another example, the video content 108 can be encoded by being compressed, visually enhanced, separated into one or more views, changed in resolution, changed in aspect ratio, or a combination thereof. In another illustrative example, the video content 108 can be encoded according to the High-Efficiency Video Coding (HEVC)/H.265 standard.

The video encoder 103 can encode the video content 108 to form the video bitstream 110. The video bitstream 110 is defined a sequence of bits representing information associated with the video content 108. For example, the video bitstream 110 can be a bit sequence representing a compression of the video content 108.

In another example, the video bitstream 110 can be a serial bitstream 122. The serial bitstream 122 is a series of bits representing the video content 108 where each bit is transmitted serially over time.

The video encoder 103 can receive the video content 108 for a scene in a variety of ways. For example, the video content 108 representing objects in the real world can be captured with a video camera, multiple cameras, generated with a computer, provided as a file, or a combination thereof.

The video content 108 can include a variety of video features. For example, the video content 108 can include single view video, multiview video, stereoscopic video, or a combination thereof. In a further example, the video content 108 can be multiview video of four or more cameras for supporting three-dimensional (3D) video viewing without 3D glasses.

The video encoder 103 can encode the video content 108 using a video syntax 114 to generate the video bitstream 110. The video syntax 114 is defined as a set of information elements that describe a coding system for encoding and decoding the video content 108. The video bitstream 110 is compliant with the video syntax 114, such as High-Efficiency Video Coding/H.265, and can include a HEVC video bitstream, an Ultra High Definition video bitstream, or a combination thereof. The video bitstream 110 can include the video syntax 114.

The video bitstream 110 can include information representing the imagery of the video content 108 and the associated control information related to the encoding of the video content 108. For example, the video bitstream 110 can include an occurrence of the video syntax 114 and an occurrence of the video content 108.

The video coding system 100 can include the video decoder 105 for decoding the video bitstream 110. The video decoder 105 is defined as a unit for receiving the video bitstream 110 and modifying the video bitstream 110 to form a video stream 112.

The video decoder 105 can decode the video bitstream 110 to form the video stream 112 using the video syntax 114. Decoding is defined as computationally modifying the video bitstream 110 to form the video stream 112. For example, decoding can decompress the video bitstream 110 to form the video stream 112 formatted for displaying on the display the display interface 120.

The video stream 112 is defined as a computationally modified version of the video content 108. For example, the video stream 112 can include a modified occurrence of the video content 108 with different resolution. The video stream 112 can include cropped decoded pictures from the video content 108.

In a further example, the video stream 112 can have a different aspect ratio, a different frame rate, different stereoscopic views, different view order, or a combination thereof than the video content 108. The video stream 112 can have different visual properties including different color parameters, color planes, contrast, hue, or a combination thereof.

The video coding system 100 can include a display processor 118. The display processor 118 can receive the video stream 112 from the video decoder 105 for display on the display interface 120. The display interface 120 is a unit that can present a visual representation of the video stream 112.

For example, the display interface 120 can include a smart phone display, a digital projector, a DVD player display, or a combination thereof. Although the video coding system 100 shows the video decoder 105, the display processor 118, and the display interface 120 as individual units, it is understood that the video decoder 105 can include the display processor 118 and the display interface 120.

The video encoder 103 can send the video bitstream 110 to the video decoder 105 over a communication path 106. The communication path 106 can be a variety of networks suitable for data transfer.

In an illustrative example, the video coding system 100 can include coded picture buffers (not shown). The coded picture buffers can act as first-in first-out buffers containing access units, where each access unit can contain one frame of the video bitstream 110.

In another illustrative example, the video coding system 100 can include a hypothetical reference decoder (not shown). The hypothetical reference decoder can be a decoder model used to constrain the variability of the video bitstream 110.

For example, the communication path 106 can include wireless communication, wired communication, optical, ultrasonic, or the combination thereof. Satellite communication, cellular communication, Bluetooth, Infrared Data Association standard (IrDA), wireless fidelity (WiFi), and worldwide interoperability for microwave access (WiMAX) are examples of wireless communication that can be included in the communication path 106. Ethernet, digital subscriber line (DSL), fiber to the home (FTTH), and plain old telephone service (POTS) are examples of wired communication that can be included in the communication path 106.

The video coding system 100 can employ a variety of video coding syntax structures. For example, the video coding system 100 can encode and decode video information using High Efficiency Video Coding/H.265. The video coding syntaxes are described in the following documents that are incorporated by reference in their entirety:
B. Bross, W. Han, J Ohm, G. Sullivan, T. Wiegand, “High-Efficiency Video Coding (HEVC) text specification draft 9”, JCTVC-K1003 d9, October 2012 (Shanghai).
B. Bross, W. Han, J Ohm, G. Sullivan, T. Wiegand, “High-Efficiency Video Coding (HEVC) text specification draft 8”, JCTVC-J1003 d7, July 2012 (Stockholm).
M. Hague, K. Sato “HEVC VUI Parameters Extensions beyond Version 1”, JCTVC-K0234, October 2012 (Shanghai).
M. Hague, K. Sato and A. Tabatabai, “VPS Extension updates in Strawman Design Approach 1 using a modified version of Scalability Mapping Table”, JCTVC-K0233, October 2012 (Shanghai).
M. Hague, A. Tabatabai, “On VUI syntax parameters”, JCTVC-F289, July 2011

Referring now to FIG. 2, therein is shown an example of the video bitstream 110. The video bitstream 110 includes an encoded occurrence of the video content 108 of FIG. 1 and can be decoded using the video syntax 114 to form the video stream 112 of FIG. 1 for display on the display interface 120 of FIG. 1.

The video bitstream 110 can include a variety of video types as indicated by a syntax type 202. The syntax type 202 is defined as an indicator of the type of video coding used to encode and decode the video bitstream 110. For example, the video content 108 can include the syntax type 202 for advanced video coding 204 (AVC), scalable video coding 206 (SVC), multiview video coding 208 (MVC), multiview video plus depth 210 (MVD), and stereoscopic video 212 (SSV).

The advanced video coding 204 and the scalable video coding 206 can be used to encode single view based video to form the video bitstream 110. The single view-based video can include the video content 108 generate from a single camera.

The multiview video coding 208, the multiview video plus depth 210, and the stereoscopic video 212 can be used to encode the video content 108 having two or more views. For example, multiview video can include the video content 108 from multiple cameras.

The video syntax 114 can include an entry count 214 for identifying the number of entries associated with each frame in the video content 108. The entry count 214 is the maximum number of entries represented in the video content 108.

The video syntax 114 can include an entry identifier 216. The entry identifier 216 is a value for differentiating between multiple coded video sequences. The coded video sequences can include occurrences of the video content 108 having a different bit-rate, frame-rate, resolution, or scalable layers for a single view video, multiview video, or stereoscopic video.

The video syntax 114 can include an iteration identifier 218. The iteration identifier 218 is a value to differentiate between individual iterations of the video content 108.

The video syntax 114 can include an iteration count 220. The iteration count 220 is a value indicating the maximum number of iterations of the video content 108.

For scalable video coding, the term iteration count can be used to indicate the number of information entries tied to different scalable video layers in the case of scalable video coding. For multiview video coding, the iteration count can be used to indicate the number of operation points tied to the number of views of the video content 108.

For example, in scalable video coding, the video content 108 can be encoded to include a base layer with additional enhancement layers to form multi-layer occurrences of the video bitstream 110. The base layer can have the lowest resolution, frame-rate, or quality.

The enhancement layers can include gradual refinements with additional left-over information used to increase the quality of the video. The scalable video layer extension can include a new baseline standard of HEVC that can be extended to cover scalable video coding.

The video syntax 114 can include an operation identifier 222. The operation identifier 222 is a value to differentiate between individual operation points of the video content 108. The operation points are information entries present for multiview video coding, such as timing information, network abstraction layer (NAL) hypothetical reference decoder (HRD) parameters, video coding layer (VCL) HRD parameters, a pic_struct_present_flag element, or a combination thereof.

The video syntax 114 can include an operation count 224. The operation count 224 is a value indicating the maximum number of operations of the video content 108.

The operation points are tied to generation of coded video sequences from various views, such as views generated by different cameras, for multiview and 3D video. For multiview video coding, an operation point is associated with a subset of the video bitstream 110 having a target output view and the other views dependent on the target output view.

The other views are dependent on the target output view if they are derived using a sub-bitstream extraction process. More than one operation point may be associated with the same subset of the video bitstream 110. For example, decoding an operation point refers to the decoding of the subset of the video bitstream corresponding to the operation point and subsequent output of the target output views as a portion of the video stream 112 of FIG. 1 for display on the device video encoder.

The video syntax 114 can include a view identifier 226. The view identifier 226 is a value to differentiate between individual views of the video content 108.

The video syntax 114 can include a view count 228. The view count 228 is a value indicating the maximum number of views of the video content 108.

For example, a single view can be a video generated by a single camera. Multiview video can be generated by multiple cameras situated at different positions and distances from the objects being viewed in a scene.

The video content 108 can include a variety of video properties. For example, the video content 108 can be high-resolution video, such as Ultra High Definition video. The video content 108 can have a pixel resolution greater than or equal to 3840 pixels by 2160 pixels or higher, including resolutions of 7680 by 4320, 8K by 2K, 4K by 2K, or a combination thereof. Although the video content 108 supports high-resolution video, it is understood that the video content 108 can also support lower resolutions, such as high definition (HD) video. The video syntax 114 can support the resolution of the video content 108.

The video content 108 can support a variety of frame rates including 15 frames per second (fps), 24 fps, 25 fps, 30 fps, 50 fps, 60 fps, and 120 fps. Although individual frame rates are described, it is understood that the video content 108 can support fixed and variable frame rates of zero frames per second and higher. The video syntax 114 can support the frame rate of the video content 108.

The video bitstream 110 can include one or more extension layers 230. The extension layers 230 are defined as portions of the video bitstream 110 supporting scalability by providing additional video information about a base video layer. The base layer can be an occurrence of one of the extension layers 230.

The video bitstream 110 can include the extension layers 230 for forming the video stream 112. The video bitstream 110 can include the base layer and additional occurrences of the extension layers 230 to represent the video content 108.

For example, the video bitstream 110 can include base layer having a resolution of 3480×2160 and other occurrences of the extension layers 230 to provide additional video information to allow the formation of a resolution of 7680 by 4320. Each of the extension layers 230 can combined with other occurrences of the extension layers 230 to form a more complete occurrence of the video stream 112. The extension layers 230 can form a hierarchy with higher layers including the lower layers.

In another example, a first occurrence 232 of the extension layers 230 can represent a 15 fps occurrence of the video stream 112, a second occurrence 234 of the extension layers 230 can represent a 30 fps occurrence of the video stream 112, and a third occurrence 236 of the extension layers 230 can represent a 60 fps occurrence of the video stream 112. The video bitstream 110 can have multiple occurrences of the extension layers 230 as indicated by an extension layer count 238. In a further example, the extension layer count 238 can have a value of three for the first occurrence 232, the second occurrence 234, and the third occurrence 236.

The first occurrence 232 of the extension layers 230 can represent a base layer that encodes the video content 108 to form the video stream 112 at 15 fps. The second occurrence 234 of the extension layers 230 can represent the difference between the base layer, such as the first occurrence 232 of the extension layers 230, and the video stream 112 of the video content 108 at 30 fps.

The second occurrence 234 can includes frames that represent the difference between the frames of the base layer and the new frames required for displaying the video content 108 at 30 fps. The third occurrence 236 of the extension layers 230 can represent the difference between the second occurrence 234 of the extension layers 230 and the video content at 60 fps.

In an illustrative example, the video decoder 105 of FIG. 1 for a smart phone can extract the second occurrence 234 of the extension layers 230 at 30 fps from the video bitstream 110, which can include the information from the first occurrence 232 and the second occurrence 234. The information in the video bitstream 110 from the third occurrence 236 of the extension layers 230 can be discarded to reduce the size of the video bitstream 110.

In another example, the extension layers 230 can represent sub-layers, temporal layers, multiview layers, quality layers, depth layers, stereoscopic layers, spatial layers, or a combination thereof. The extension layers 230 can include a mixed configuration of different types of layers to allow the video bitstream 110 to support multiple types of scalability.

Referring now to FIG. 3, therein is shown an example of a HRD syntax 302. The HRD syntax 302 describes the parameters associated with the hypothetical reference decoder.

The HRD syntax 302 includes elements as described in the HRD syntax table of FIG. 3. The elements of the HRD syntax 302 are arranged in a hierarchical structure as described in the HRD syntax table of FIG. 3.

The HRD syntax 302 can include a HRD syntax header 304, such as the hrd_parameters element. The HRD syntax header 304 is a descriptor for identifying the HRD syntax 302.

The HRD syntax 302 can include the timing present information, the NAL HRD parameters, the VCL HRD parameters, and the fixed pic rate information. The timing present information can include a timing information present flag 312, a tick units 314, and a time scale 316.

The timing information present flag 312, such as the timing_info_present_flag element, can indicate whether timing information is included in the video bitstream 110 of FIG. 1. The timing information present flag 312 can have a value of 1 to indicate timing information is in the video bitstream 110 and a value of 0 to indicate that timing information is not included in the video bitstream 110.

Although a value of 1 is described, it is understood that a value of 1 indicates that the value is TRUE and other values can be used to indicate the value of TRUE. Similarly, a value of 0 is described to indicate that the value is FALSE, but it is understood that other values, such as a negative value, may be used to indicate a FALSE value.

The tick units 314, such as the num_units_in_tick element, can indicate the number of time units of a clock operating at the frequency of the time scale 316. For example, the tick units 314 can have corresponding to the minimum interval of time that can be represented in the video bitstream 110. The time scale 316, such as the time_scale element, is the number of time units that pass in one second.

The HRD syntax 302 can include a network abstraction layer (NAL) hypothetical reference decoder (HRD) parameters present flag 318, such as the nal_hrd_parameters_present_flag element, to indicate the presence of the NAL HRD parameter information. The NAL HRD parameters present flag 318 can have a value of 1 to indicate that the HRD syntax 302 is present and a value of 0 to indicate the HRD syntax 302 is not present in the video bitstream 110.

The HRD syntax 302 can include a video coding layer (VCL) HRD parameters present flag 320, such as the vcl_hrd_parameters_present_flag element, to indicate the presence of the HRD information for VCL. The VCL HRD parameters present flag 320 can have a value of 1 to indicate that the HRD syntax 302 is present and a value of 0 to indicate the HRD syntax 302 is not present in the video bitstream 110.

If the NAL HRD parameters present flag 318 or the VCL HRD parameters present flag 320 has a value of 1, then the HRD syntax 302 can include additional elements. For example, the HRD syntax 302 can include a sub-picture CPB parameters present flag 322, a bit rate scale 326, a CPB size scale 328, an initial CPB removal delay length 330, a CPB removal delay length 332, and a decoded picture buffer (DPB) output delay length 334.

The HRD syntax 302 can include a sub-picture coded picture buffer (CPB) parameters present flag 322, such as the sub_pic_cpb_params_present_flag element, to indicate if sub-picture CPB parameters are present in the video bitstream 110. If the sub-picture CPB parameters present flag 322 has a value of 1, then the HRD syntax 302 can include a tick divisor 324, such as a tick_divisor_minus2 element, to specify the minimum interval of time that can be represented in the video bitstream 110.

The HRD syntax 302 can include a bit rate scale 326, such as a bit_rate_scale element. The bit rate scale 326 specifies the maximum input bit rate of coded picture buffer.

The HRD syntax 302 can include the CPB size scale 328, such as a cpb_size_scale element. The CPB size scale 328 is for determining the size of the CPB.

The HRD syntax 302 can include the initial CPB removal delay length 330, such as an initial_cpb_removal_delay_length_minus1 element. The initial CPB removal delay length 330 indicates the bit length of the elements initial_cpb_removal_delay and initial_cpb_removal_delay offset of the buffering period SEI message.

The HRD syntax 302 can include the CPB removal delay length 332, such as a cpb_removal_delay_length_minus1 element. The CPB removal delay length 332 can specify the bit length of the elements cpb_removal_delay in the picture timing SEI message.

The HRD syntax 302 can include the DPB output delay length 334, such as a dpb_output_delay_length_minus1 element. The DPB output delay length 334 indicates the size of the decoded picture buffer.

The HRD syntax 302 can include can include a set of parameters for each occurrence of the extension layers 230 of FIG. 2. The HRD syntax 302 can include a loop structure using an iterator, such as [i], to describe parameters for each occurrence of the extension layers 230.

The HRD syntax 302 can include a sub-layer count 306, such as the MaxNumSubLayersMinus1 element. The sub-layer count 306 indicates the maximum number of the sub-layers in the video bitstream 110. The HRD syntax 302 can include a common information present flag 308, such as the commonInfPresentFlag element, which can indicate if common HRD information is present.

The HRD syntax 302 can include a fixed picture rate flag 336, such as a fixed_pic_rate_flag element, to indicate whether the temporal distance between the HRD output times of any two consecutive pictures in the video bitstream 110 is constrained. If the fixed picture rate flag 336 has a value of 1, then the temporal distance between any two consecutive pictures is constrained and a value of 0 if not constrained.

If the fixed picture rate flag 336 has a value of 1, then the HRD syntax 302 can include a picture duration 338, such as a pic_duration_in_tc_minus1 element. The picture duration 338 can indicate the temporal distance between the HRD output times of any two consecutive pictures in output order in the coded video sequence.

The HRD syntax 302 can include a low delay HRD flag 340, such as a low_delay_hrd_flag element. The low delay HRD flag 340 can indicate the HRD operational mode.

The HRD syntax 302 can include a CPB count 342, such as a cpb_cnt_minus1 element. The CPB count 342 can indicate the number of alternative CPB specification in the video bitstream 110.

If the NAL HRD parameters present flag 318 or the VCL HRD parameters present flag 320 have a value of 1, then the HRD syntax 302 can include a HRD parameters sub-layer 344, such as a hrd_parameters sub layer element, for each occurrence of the extension layers 230. The HRD parameters sub-layer 344 can describe the parameters related to each sub-layer.

The HRD syntax 302 can represent a set of normative requirements for the video bitstream 110. The HRD syntax 302 can be used to control the bit rate of the video bitstream 110. For example, the HRD syntax 302 can include parameters for controlling variable or constant bit rate operations, low-delay behavior, and delay-tolerant behavior.

In another example, the HRD syntax 302 can be used to control the coded picture buffer performance, the number of coded picture buffers, and the size of the coded picture buffers using parameters such as the bit rate scale 326, the CPB count 342, and the CPB size scale 328. The HRD syntax 302 can be used for controlling the decoded picture buffer using parameters such as the DPB output delay length 334.

It has been discovered that using the HRD syntax 302 provides improved performance by enabling finer grained control over the processing of the individual occurrences of the coded picture buffer. Using individual occurrences of the HRD syntax 302 can provide improved processing speed by taking advantage of individual differences between different occurrences of the CPB.

It has been discovered that encoding and decoding the video content 108 of FIG. 1 using the HRD syntax 302 can reduce the size of the video bitstream 110 and reduces the amount of video buffering required to display the video stream 112 of FIG. 1. Reducing the size of the video bitstream 110 increases functionality and increases the performance of display of the video stream 112.

Referring now to FIG. 4, therein is shown an example of a High Efficiency Video Coding (HEVC) Video Usability Information (VUI) syntax 402. The HEVC VUI syntax 402 includes information about the video bitstream 110 of FIG. 1 to permit additional application usability features for the video content 108 of FIG. 1.

The HEVC VUI syntax 402 describes the elements in the HEVC VUI syntax table of FIG. 3. The elements of the HEVC VUI syntax 402 are arranged in a hierarchical structure as described in the HEVC VUI syntax table of FIG. 3.

The HEVC VUI syntax 402 includes a HEVC VUI syntax header 404, such as a vui_parameters element. The HEVC VUI syntax header 404 is a descriptor for identifying the HEVC VUI syntax 402. The HEVC VUI syntax 402 is used to encode and decode the video bitstream 110.

The HEVC VUI syntax 402 can include an aspect ratio flag 406, such as the aspect_ratio_info_present_flag element. The aspect ratio flag 406 can indicate that aspect ratio information is encoded in the video bitstream 110. The aspect ratio flag 406 can have a value 0 to indicate that aspect ratio information is not in the video bitstream 110 and a value of 1 to indicate that aspect ratio information is included in the video bitstream 110.

The HEVC VUI syntax 402 can include an aspect ratio indicator 408, such as the aspect_ratio_idc element. The aspect ratio indicator 408 is a value describing an aspect ratio of the video content 108 of FIG. 1. For example, the aspect ratio indicator 408, can include an index value for an enumerated list of predefined aspect ratios for the video content 108. In a further example, the aspect ratio indicator 408 can include a value indicating that the aspect ratio can be described by individual values for an aspect ratio width 410 and an aspect ratio height 412.

The HEVC VUI syntax 402 can include the aspect ratio width 410, such as the sar_width element, The aspect ratio width 410 can describe the width of the video content 108. The aspect ratio width 410 can describe the dimensions of the video content in ratios, pixels, lines, inches, centimeters, or a combination thereof.

The HEVC VUI syntax 402 can include the aspect ratio height 412, such as the sar_height element. The aspect ratio height 412 can describe the height of the video content 108. The aspect ratio height 412 can describe the dimensions of the video content in ratios, pixels, lines, inches, centimeters, or a combination thereof.

The HEVC VUI syntax 402 can include an overscan present flag 414, such as the overscan_info_present_flag element. The overscan present flag 414 can indicate if overscan information is included in the video bitstream 110. The overscan present flag 414 can have a value of 1 to indicate that overscan information is present in the video bitstream or a value of 0 to indicate that overscan information is not present in the video bitstream 110.

Overscan is defined as display processes in which some parts near the borders of the cropped decoded pictures of the video stream 112 of FIG. 1 are not visible in the display area of the video stream 112. Underscan is defined as display processes in which the entire cropped decoded pictures of the video stream 112 are visible in the display area, but do not cover the entire display area.

The HEVC VUI syntax 402 can include an overscan appropriate flag 416, such as an overscan_appropriate_flag element. The overscan appropriate flag 416 can indicate that the video content 108 encoded in the video bitstream 110 can be displayed using overscan.

The overscan appropriate flag 416 can have a value of 1 to indicate that the cropped decoded pictures of the video stream 112 are suitable for display using overscan. The overscan appropriate flag 416 can have a value of zero to indicate that the cropped decoded pictures of the video stream 112 contain visually important information and should not be displayed using overscan.

The HEVC VUI syntax 402 can include a video signal present flag 418, such as the video_signal_type_present_flag element. The video signal present flag 418 can indicate that video signal type information is included in the video bitstream 110. The video signal present flag 418 can have a value of 1 to indicate that additional video signal type information is present in the video bitstream 110. The video signal present flag 418 can have a value of 0 to indicate that no video signal type information is present in the video bitstream 110.

The HEVC VUI syntax 402 can include a video format 420, such as the video_format element. The video format 420 can indicate the format of the video.

The HEVC VUI syntax 402 can include a video full range flag 422, such as the video_full_range_flag element. The video full range flag 422 can indicate the black level and the range of the luma and chroma signals for the video content 108 encoded in the video bitstream 110.

The HEVC VUI syntax 402 can include a color description present flag 424, such as the colour_description_present_flag element. The color description present flag 424 can indicate the presence of color description information in the video bitstream 110.

The color description present flag 424 can have a value of 0 to indicate that no other color description information is included in the video bitstream 110. The color description present flag 424 can have a value of 1 to indicate that a color primaries 426, a transfer characteristics 428, and a matrix coefficient 430 are included in the video bitstream 110.

The HEVC VUI syntax 402 can include the color primaries 426, such as the colour_primaries element. The color primaries 426 can indicate the color scheme used in the video content 108. For example, the color primaries 426 can indicate the chromaticity coordinates of the source primaries.

The HEVC VUI syntax 402 can include the transfer characteristics 428, such as the transfer characteristics element. The transfer characteristics 428 can indicate the opto-electronic transfer characteristics of the video content 108. For example, the transfer characteristics 428 can be an enumerated value describing a predefined set of display characteristics.

The HEVC VUI syntax 402 can include the matrix coefficient 430, such as the matrix_coefficient element. The matrix coefficient 430 can indicate coefficient used to derive luma and chroma signals from the red, green, and blue primaries indicated by the color primaries 426. The matrix coefficient 430 can be used to computationally transform a set of red, blue, and green color coordinates to luma and chroma equivalents.

The HEVC VUI syntax 402 can include a chroma location information present flag 432, such as the chroma_loc_info_present_flag element. The chroma location information present flag 432 can have a value of 1 to indicate that a chroma top field sample 434 and a chroma bottom field sample 436 are present in the video bitstream 110.

The HEVC VUI syntax 402 can include the chroma top field sample 434, such as the chroma_sample_loc_type_top_field element. The chroma top field sample 434 is an enumerated value to specify the location of chroma samples for the top field in the video bitstream 110.

The HEVC VUI syntax 402 can include the chroma bottom field sample 436, such as the chroma_sample_loc_type_bottom_field element. The chroma bottom field sample 436 is an enumerated value to specify the location of chroma samples for the bottom field in the video bitstream 110.

The HEVC VUI syntax 402 can include a neutral chroma flag 438, such as the neutral_chroma_indication_flag element. The neutral chroma flag 438 can indicate whether the decoded chroma samples are equal to one. For example, if the neutral chroma flag 438 has a value of 1, then all of the decoded chroma samples are set to 1. If the neutral chroma flag 438 has a value of 0, then the decoded chroma samples are not limited to 1.

The HEVC VUI syntax 402 can include a field sequence flag 440, such as the field_seq_flag, can indicate whether coded video sequence information includes video representing fields. The field sequence flag 440 can have a value of 1 to indicate the coded video sequence of the video bitstream 110 includes field level pictures, and a value of 0 to indicate frame level pictures.

The HEVC VUI syntax 402 can include a HEVC extension flag 442, such as a hevc_extension_flag element. The HEVC extension flag 442 can indicate whether VUI parameters extension layer information is included in the video bitstream 110. For example, if the HEVC extension flag 442 has a value of 1, then the video bitstream 110 can include a VUI extension layer structure 444. If the HEVC extension flag 442 has a value of 0, then the VUI parameters extension layer information is not included in the video bitstream 110.

The HEVC VUI syntax 402 can include the VUI extension layer structure 444, such as the vui_parameters_ext_layer element. The VUI extension layer structure 444 can include information about the extension layers 230 of FIG. 3 of the video bitstream 110. The VUI extension layer structure 444 is further defined in the VUI extension syntax sections below.

The VUI extension layer structure 444 can be indexed with an extension layers maximum 445, such as the sps_max_layers_minus1 element. The extension layers maximum 445 indicates the number of layers used to extend the video bitstream 110.

The VUI extension layer structure 444 enables coded video content having different types of scalability. For example, the VUI extension layer structure 444 provides dimension and scalability information about the extension layers 230 to support multi-view coding, scalable coding, three-dimensional video coding, quality coding, spatial coding, or a combination thereof.

The HEVC VUI syntax 402 can include a HRD parameters present flag 446, such as a hrd_parameters_present flag element. The HRD parameters present flag 446 can indicate the HRD parameters are included in the HRD syntax 302 of FIG. 3. The HRD parameters present flag 446 can have a value of 1 to indicate that a HRD parameters structure 448 is present and a value of 0 to indicate the HRD parameters structure 448 is not present in the video bitstream 110.

The HEVC VUI syntax 402 can include the HRD parameters structure 448. The HRD parameters structure 448 is an occurrence of the HRD syntax 302 of FIG. 3. The HRD parameters structure 448 is described in detail in the HRD syntax section.

The HRD parameters structure 448 can be indexed with the common information present flag 308 of FIG. 3, such as a commonInfPresentFlag element. The common information present flag 308 indicates that common information is present in the HRD parameters structure 448.

The HRD parameters structure 448 can be indexed with a maximum sub-layers count 449, such as a MaxNumSubLayersMinus 1 element. The maximum sub-layers count 449 can be used to indicate the limit of the set of parameters in the HRD parameters structure 448 for each of the individual sub-layers.

The HEVC VUI syntax 402 can include a bitstream restriction flag 450, such as a bitstream_restriction_flag element. The bitstream restriction flag 450 can indicate that the coded video sequence bitstream restriction parameters are present in the video bitstream 110. If the bitstream restriction flag 450 has a value of 1 the HEVC VUI syntax 402 can include a tiles fixed structure flag 452, a motion vector flag 454, a max bytes per picture denomination 456, a maximum bits per minimum cu denomination 458, a maximum motion vector horizontal length 460, and a maximum motion vector vertical length 462.

The HEVC VUI syntax 402 can include the tiles fixed structure flag 452, such as a tiles_fixed_structure_flag element, can indicate that each picture in the coded video sequence has the same number of tiles. The tiles fixed structure flag 452 can have to value of 1 to indicate that fixed tiles and a value of 0 to indicate otherwise.

The HEVC VUI syntax 402 can include the motion vector flag 454, such as a motion_vector_over_pic_boundaries_flag element, can indicate that no sample outside the picture boundaries is used for prediction. If the motion vector flag 454 has a value of 1, then one or more samples outside the picture boundaries may be used for prediction, otherwise no samples are used for prediction.

The HEVC VUI syntax 402 can include the max bytes per picture denomination 456, such as a max_bytes_per_pic_denom element, is a value indicating the maximum number of bytes for the sum of the sizes of the VCL NAL units associated with any coded picture in the coded video sequence. If the max bytes per picture denomination 456 has a value of 0, then no limits are indicated. Otherwise, it is a requirement of bitstream conformance that no coded pictures shall be represented in the video bitstream 110 by more bytes than the max bytes per picture denomination 456.

The HEVC VUI syntax 402 can include the maximum bits per minimum cu denomination 458, such as a max_bits_per_min_cu_denom element, is a value indicating the an upper bound for the number of coded bits of coding unit data for any coding block in any picture of the coded video sequence. If the maximum bits per minimum cu denomination 458 has a value of 0, then no limit is indicated. Otherwise, is a requirement of bitstream conformance that no coding unit shall be represented in the bitstream by more than the maximum bits per minimum cu denomination 458.

The HEVC VUI syntax 402 can include the maximum motion vector horizontal length 460, such as a log 2_max_mv_length_horizontal element, indicates the maximum absolute value of a decoded horizontal motion vector component for all pictures in the video bitstream 110. The maximum motion vector vertical length 462, such as a log 2_max_mv_length_vertical element, indicates the maximum absolute value of a decoded vertical motion vector component for all pictures in the video bitstream 110.

Although a value of 1 is described, it is understood that a value of 1 indicates that the value is TRUE and other values can be used to indicate the value of TRUE. Similarly, a value of 0 is described to indicate that the value is FALSE, but it is understood that other values, such as a negative value, may be used to indicate a FALSE value.

It has been discovered that encoding and decoding the video content 108 using the HRD syntax 302 can reduce the size of the video bitstream 110 and reduces the amount of video buffering required to display the video stream 112. Reducing the size of the video bitstream 110 increases functionality and increases the performance of display of the video stream 112.

Referring now to FIG. 5, therein is shown an example of a VUI first extension syntax 502. The VUI first extension syntax 502 provides information for each occurrence of the extension layers 230 of FIG. 2 in the video bitstream 110 of FIG. 1 for supporting scalability. The VUI first extension syntax 502 is an occurrence of the VUI extension layer structure 444 of FIG. 4.

The VUI first extension syntax 502 describes the elements in the VUI first extension syntax table of FIG. 5. The elements of the VUI first extension syntax 502 are arranged in a hierarchical structure as described in the VUI first extension syntax table of FIG. 5.

The VUI first extension syntax 502 can describe the VUI parameters of the video coding system 100 of FIG. 1. For example, the VUI first extension syntax 502 can be an occurrence of the HEVC VUI syntax 402 of FIG. 4. Terms such as first or second are used for identification purposes only and do not indicate any order, priority, importance, or precedence.

The VUI first extension syntax 502 includes a VUI first extension syntax header 504, such as the vui_parameters_ext_layer element. The VUI first extension syntax header 504 is a descriptor for identifying the VUI first extension syntax 502.

The VUI first extension syntax 502 can be indexed based on an extension layers count 506, such as the MaxNumLayersMinus1 element. The extension layers count 506 represents the maximum number of the extension layers 230 in the video bitstream 110.

The VUI first extension syntax 502 can include a first loop structure for representing the scalability parameters for each of the extension layers 230. The first loop structure can include an iterator, such as [i], for differentiating between each of the extension layers 230 up to the maximum of the extension layers count 506. The first loop structure can include information for each of the extension layers 230 including a VUI scalability type 508 and a first dimension count 510.

The VUI first extension syntax 502 can include the VUI scalability type 508, such as the vui_scalability_type element. The VUI scalability type 508 is an array value with one value for each of the extension layers 230.

The VUI scalability type 508 can be an enumerated value indicating the type of scalability implemented in the video bitstream 110. For example, the VUI scalability type 508 can represent different implementations of scalability such as base HEVC, spatial scalability, quality scalability, multiview scalability, depth scalability, or a combination thereof. The VUI scalability type 508 can also include references to future types of scalability that are designated as reserved types of scalability for the purposes of defining the enumerated values for the VUI scalability type 508.

The VUI scalability type 508 can represent multiple types of scalability with each type of scalability representing a separate dimension of scalability. The VUI scalability type 508 can have an associated number of dimensions for the types of scalability represented.

In an illustrative example, the VUI scalability type 508 can have a value of 0 to represent no additional scalability other than the base HEVC occurrence in the video bitstream 110 and one dimension of scalability. The VUI scalability type 508 can have a value of 1 to represent the video bitstream 110 having spatial and quality scalability with two dimensions of scalability. The VUI scalability type 508 can have a value of 4 to represent the video bitstream 110 having multiview and depth scalability with two dimensions of scalability. The VUI scalability type 508 can have a value of 7 to represent the video bitstream 110 having multiview, spatial, quality, and depth scalability with four dimensions of scalability. Each type of scalability represents one dimension of scalability.

The VUI first extension syntax 502 can include the first dimension count 510, such as a num_dimensions) element. The first dimension count 510 is the maximum number of dimensions of the VUI scalability type 508. For example, if the VUI scalability type 508 has a value of 8 representing multiview, depth, quality, depth, and a reserved scalability, then the first dimension count 510 has a value of five to represent each of the five types of scalability supported in the video bitstream 110. The first dimension count 510 can be a separate value associated with each of the extension layers 230.

The VUI first extension syntax 502 can include a second loop structure for representing a VUI dimension identification 514 within the first loop structure. The second loop structure can include a second iterator, such as [j], for differentiating between each dimension of the VUI scalability type 508 for each of the extension layers 230 represented in the first loop structure. The second loop structure can include a dimension identification length 512 and the VUI dimension identification 514.

The VUI first extension syntax 502 can include the dimension identification length 512, such as the dimension_id_len[j] element, within the second loop structure. The dimension identification length 512 is a value for representing the number of bits used to represent the VUI dimension identification 514. The dimension identification length 512 is the bit-length of the VUI dimension identification 514. The dimension identification length 512 can be retrieved from a pre-defined scalability type table described below in the section for FIG. 10.

The VUI first extension syntax 502 can include the VUI dimension identification 514, such as the vui_dimension_id[i][j] element, within the first loop structure and the second loop structure. The VUI dimension identification 514 can be indexed on both [i] and [j].

The VUI dimension identification 514 can be an enumerated value indicating the type of scalability implemented in the video bitstream 110. The VUI dimension identification 514 can include the view order index, depth flag, dependency identification, quality identification, reserved values, or a combination thereof. The VUI dimension identification 514 can be extracted from the video bitstream 110 as an array of vui_dimension_id[i][j] elements.

The VUI first extension syntax 502 can include a VUI sub-scalability type 516, such as a vui_sub_scalability_type[i] element. The VUI sub-scalability type 516 is within the first loop structure and outside of the second loop structure. The VUI sub-scalability type 516 is an enumerated value indicating the viewing mode supported in the video bitstream 110. For example, the VUI sub-scalability type 516 can be indicate the viewing mode such as a mono-view two-dimensional (2D), interlace (2D), frame-compatible three-dimensional (3D), stereo-view (3D), multi-view (3D), a reserved type, or a combination thereof.

The VUI sub-scalability type 516 can be derived from the vui_dimension_id[i][j] elements. The VUI sub-scalability type 516 can be used as an index to the sub-scalability table 902 of FIG. 9 linking to the sub_scalability_type element as described in the section for FIG. 9.

The VUI sub-scalability type 516 can be indexed based on the iterator [i] to represent separate occurrences of the VUI sub-scalability type 516 for each of the extension layers 230. The VUI sub-scalability type 516 can be an enumerated value to indicate the sub-scalability type for the i-th scalability layer in the coded video sequence of the video bitstream 110. Each of the scalability layers can be one of the extension layers 230.

The VUI sub-scalability type 516 can be determined based on the VUI dimension identification 514. For example, the VUI sub-scalability type 516 can be equal to the VUI dimension identification 514 for the first dimension of each of the extension layers 230, such as the vui_dimension_id[i][1] element.

The VUI first extension syntax 502 can include a second dimension count 518, such as a num_dimensions2 element. The second dimension count 518 is the maximum number of dimensions of the VUI sub-scalability type 516.

For example, if the VUI sub-scalability type 516 has a value of 0 to indicate mono-view (2D) with zero dimensions. The VUI sub-scalability type 516 has a value of 1 to indicate interlace (2D) with one dimension, such as a top_field_first element. The VUI sub-scalability type 516 has a value of 2 to indicate frame-compatible (3D) with three dimensions, such as the depth_flag, left_view_first, and fc_format elements.

The depth_flag element indicates whether the 2D depth information is present for a 3D occurrence of the video content 108. Using one or two views as a reference, the depth information data can be used to extrapolate intermediate views of 3D video contents.

The left_view_first element can indicate the order of view elements in the video bitstream 110 having 3D content. The left_view_first element can indicate that the view-frame from left-view is present in the video bitstream 110 first as a first frame, then the right-view frame is included after the left-view frame.

The fc_format element is a frame packing format where left- and right-views of 3D video content are packed into the format based on the value of fc_format. The fc_format element can enable the existing 2D video transport streams to can carry 3D video information according to this frame-packing format.

In a further example, the VUI sub-scalability type 516 has a value of 3 to indicate stereo-view (3D) with three dimensions, such as depth_flag, view1_id, and view2_id elements. The VUI sub-scalability type 516 has a value of 4 to indicate multi-view (3D) with one dimension, such as the depth_flag element. The VUI sub-scalability type 516 can reserve the values of 5-15 for expansion.

The VUI first extension syntax 502 can include a third loop structure for representing the VUI dimension identification 514 within the first loop structure. The third loop structure can include the second iterator, such as [j], for differentiating between each dimension of the VUI scalability type 508 for each of the extension layers 230 represented in the first loop structure. The third loop structure can include a dimension sub identification length 520 and the VUI dimension identification 514.

The VUI first extension syntax 502 can include the dimension sub identification length 520, such as the dimensionSub_id_len[j] element, within the third loop structure. The dimension identification length 512 is a value for representing the number of bits used to represent the VUI dimension identification 514.

The VUI first extension syntax 502 can include the VUI dimension identification 514, such as the vui_dimension_id[i][j] element, within the first loop structure and the second loop structure. The VUI dimension identification 514 can be indexed on both [i] and [j].

The VUI dimension identification 514 can be an enumerated value indicating the type of scalability implemented in the video bitstream 110. The VUI dimension identification 514 can include the view order index, depth flag, dependency identification, quality identification, reserved values, or a combination thereof.

For example, the VUI dimension identification 514 can have a variable bit length based on the dimension identification length 512. The length of the VUI dimension identification 514 can be represented by the nb element, which can be retrieved from a scalability type table 702 described below in the section for FIG. 7.

In another example, the VUI dimension identification 514 can have a variable bit length based on the dimension sub identification length 520. The length of the VUI dimension identification 514 can be represented by the nb element, which can be retrieved from a sub-scalability table 902 of FIG. 9 as described below in the section for FIG. 9.

The VUI first extension syntax 502 can include a VUI view counter 522, such as the vui_num_views[i] element. The VUI view counter 522 is the total number of views for the i-th scalability layer coded in the video bitstream 110 having multi-view coding. The VUI view counter 522 is included in the video bitstream 110 when the VUI sub-scalability type 516 has a value of 4 indicating multi-view coding.

The VUI first extension syntax 502 can include a fourth loop structure for representing the VUI dimension identification 514 within the first loop structure. The fourth loop structure can include the second iterator, such as [j], for differentiating between each dimension of the VUI scalability type 508 for each of the extension layers 230 represented in the first loop structure. The fourth loop structure can include a VUI view identification 524.

The VUI first extension syntax 502 can include the VUI view identification 524, such as the vui_view_id[i][j] element, within the fourth loop structure. The VUI view identification 524 is a value for representing the identification value for the j-th view of the i-th scalability layer coded in the 3D video bitstream with multi-view coding. The fourth loop structure and the VUI view identification 524 are included in the video bitstream 110 when the VUI sub-scalability type 516 has a value of 4 indicating multi-view coding.

Although a value of 1 is described, it is understood that a value of 1 indicates that the value is TRUE and other values can be used to indicate the value of TRUE. Similarly, a value of 0 is described to indicate that the value is FALSE, but it is understood that other values, such as a negative value, may be used to indicate a FALSE value.

It has been discovered extracting the VUI dimension identification 514 from the VUI first extension syntax 502 increases performance by performing a lookup of the VUI dimension identification 514 using a pre-defined table. Performing the lookup reduces the computational requirements for extracting the VUI dimension identification 514 from the video bitstream 110.

Referring now to FIG. 6, therein is shown an example of a VUI second extension syntax 602. The VUI second extension syntax 602 provides information for each occurrence of the extension layers 230 of FIG. 2 in the video bitstream 110 of FIG. 1 for supporting scalability. The VUI second extension syntax 602 is an occurrence of the VUI extension layer structure 444 of FIG. 4.

The VUI second extension syntax 602 describes the elements in the VUI second extension syntax table of FIG. 6. The elements of the VUI second extension syntax 602 are arranged in a hierarchical structure as described in the VUI second extension syntax table of FIG. 6.

The VUI second extension syntax 602 can describe the VUI parameters of the video coding system 100 of FIG. 1. For example, the VUI second extension syntax 602 can be an occurrence of the HEVC VUI syntax 402 of FIG. 4. Terms such as first or second are used for identification purposes only and do not indicate any order, priority, importance, or precedence.

The VUI second extension syntax 602 includes a VUI second extension syntax header 604, such as the vui_parameters_ext_layer element. The VUI second extension syntax header 604 is a descriptor for identifying the VUI second extension syntax 602.

The VUI second extension syntax 602 can be indexed based on the extension layers count 506 of FIG. 5, such as the MaxNumLayersMinus1 element. The extension layers count 506 represents the maximum number of the extension layers 230 in the video bitstream 110.

The VUI second extension syntax 602 can include a first loop structure for representing the scalability parameters for each of the extension layers 230. The first loop structure can include an iterator, such as [i], for differentiating between each of the extension layers 230 up to the maximum of the extension layers count 506. The first loop structure can include information for each of the extension layers 230 including a VUI dimension count 606 for each of the extension layers 230.

The VUI second extension syntax 602 can include the VUI dimension count 606, such as the vui_num_dimensions_minus1 [i] element, for each of the extension layers 230. The VUI dimension count 606 is the maximum number of scalability dimensions for each of the extension layers 230. The VUI dimension count 606 is included within the first loop structure of the VUI second extension syntax 602.

The VUI second extension syntax 602 can include a second loop structure for representing the scalability dimensions for each of the extension layers 230. The second loop structure can include an iterator, such as [j], for differentiating between each of the scalability dimensions. The second loop structure can include a VUI dimension type 608 and the VUI dimension identification 514 for each of the dimensions of each of the extension layers 230. The scalability dimensions are types of data representations for compressing the video data.

The VUI second extension syntax 602 can include the VUI dimension type 608, such as the vui_dimension_type [i][j] element, for each of the dimensions of each of the extension layers 230. The VUI dimension type 608 is the maximum number of scalability dimensions for each of the extension layers 230. The VUI dimension count 606 is included within the first loop structure of the VUI second extension syntax 602.

The VUI second extension syntax 602 can include the VUI dimension type 608, such as the vui_dimension_type[i][j] element, for each of the dimensions of each of the extension layers 230. The VUI dimension type 608 is an enumerated value indicating the VUI dimension identification 514 associated with each of the VUI dimension type 608. For example, the VUI dimension type 608 can be an integer value from 0 to 15. In another example, the VUI dimension type 608 can be represented by a four-bit binary value.

The VUI second extension syntax 602 can include the VUI dimension identification 514, such as the vui_dimension_id[i][j] element. The VUI dimension identification 514 can be an enumerated value indicating the type of scalability implemented in the video bitstream 110. The VUI dimension identification 514 can include the view order index, depth flag, dependency identification, quality identification, reserved values, or a combination thereof. Each of the VUI dimension identification 514 can be associated with a corresponding occurrence of the VUI dimension type 608. The dimension type 608 can indicate the type of scalability dimensions present in the video bitstream 110.

Although a value of 1 is described, it is understood that a value of 1 indicates that the value is TRUE and other values can be used to indicate the value of TRUE. Similarly, a value of 0 is described to indicate that the value is FALSE, but it is understood that other values, such as a negative value, may be used to indicate a FALSE value.

It has been discovered extracting the VUI dimension identification 514 from the VUI second extension syntax 602 increases performance by performing a lookup of the VUI dimension identification 514 using the VUI dimension type 608 in a pre-defined table. Performing the lookup reduces the computational requirements for extracting the VUI dimension identification 514 from the video bitstream 110.

It has been discovered that the VUI second extension syntax 602 can improve performance and increase decoding flexibility by providing a general purpose scalability type bit-allocation mechanism for different scalability dimensions. The loop structure of the VUI second extension syntax 602 provides a flexible configuration for mapping the scalability dimensions to the VUI dimension identification 514.

Referring now to FIG. 7, therein is shown an example of a scalability type table 702. The scalability type table 702 provides the VUI dimension count 606 of FIG. 6 and scalability dimensions for each of the enumerated values of the VUI scalability type 508 of FIG. 5.

The scalability type table 702 can include the VUI scalability type 508, the VUI dimension count 606, and the scalability dimensions. The scalability dimensions can include base HEVC, spatial scalability, quality scalability, multi-view scalability, depth scalability, or a combination thereof. The scalability type table 702 can be pre-defined to allow quick access to the scalability dimension information for each of the VUI scalability type 508. The enumerated value of the VUI scalability type 508 can index the scalability type table 702 for determining the number and type of scalability dimensions present in the video bitstream 110.

Referring now to FIG. 8, therein is shown an example of a dimension type table 802. The dimension type table 802 provides the VUI dimension identification 514 of FIG. 5 for each of the enumerated values of the VUI dimension type 608 of FIG. 6.

The VUI dimension identification 514 can include the view order index, the depth flag, the dependency identification, the quality identification, and reserved entries. The dimension type table 802 can be pre-defined to allow quick access to the VUI dimension identification 514 for each occurrence of the VUI dimension type 608.

The VUI dimension type 608 can indicate the order number of the scalability dimensions elements of the scalability type table 702 of FIG. 7. The VUI dimension type 608 can indicate the VUI dimension identification 608 of the dimension type table 802.

Referring now to FIG. 9, therein is shown an example of a sub-scalability table 902. The sub-scalability table 902 provides the VUI sub-scalability type 516 of FIG. 5, a sub-scalability dimension count 904, the VUI dimension identification 514 of FIG. 5, and the dimension sub identification length 520 of FIG. 5 for each of the enumerated values of the VUI sub-scalability type 516.

The VUI dimension identification 514 can include the view order index, the depth flag, the dependency identification, the quality identification, and reserved entries. The sub-scalability table 902 can be pre-defined to allow quick access to the VUI sub-scalability type 516, the sub-scalability dimension count 904, the VUI dimension identification 514, and the dimension sub identification length 520 for each of the enumerated values of the VUI sub-scalability type 516. The VUI sub-scalability type 516 can index the sub-scalability table 902 to determine the number and type of the sub-scalability dimensions are present in the video bitstream 110.

Referring now to FIG. 10, therein is shown an example of a scalability type mapping table 1002. The scalability type mapping table 1002 can provide the mapping of the VUI scalability type 508 of FIG. 5 to the VUI dimension identification 514 of FIG. 5.

The scalability type mapping table 1002 can include the VUI scalability type 504 of FIG. 5, the VUI dimension count 606 of FIG. 6, the scalability dimensions, the VUI dimension identification 514, and the dimension identification length 512 of FIG. 5. The scalability dimensions can include base HEVC, spatial scalability, quality scalability, multi-view scalability, depth scalability, or a combination thereof.

The VUI dimension identification 514 can include the coding_type, sub_scalabilty_type, dependency identification, quality identification, and reserved entries. The scalability type mapping table 1002 can be pre-defined to allow quick access to the VUI dimension identification 514, the VUI dimension count 606, the scalability dimensions, the VUI dimension identification 514, and the dimension identification length 512 for each of the enumerated values of the VUI scalability type 508.

In an illustrative example, the VUI dimension identification 514 can include the coding_type element for mapping to a video coding type element. In another illustrative example, the VUI dimension identification 514 can include the sub_scalabilty_type element for providing the VUI sub-scalability type 516 of FIG. 5, the sub-scalability dimension count 904 of FIG. 9, the VUI dimension identification 514 of FIG. 5, and the dimension sub identification length 520 of FIG. 5 based on the enumerated value of the sub_scalabilty_type element in the sub-scalability table 902 of FIG. 9.

Referring now to FIG. 11, therein is shown an example of a coding type table 1102. The coding type table 1102 provides the video coding type for each of the enumerated values of the coding_type element. The coding type table 1102 can be pre-defined to provide quick access to the video coding type element.

In an illustrative example, if the coding_type element is 0, then video coding type is HEVC. If the coding_type element is 1, then the video coding type is AVC. The coding type table 1102 can include reserved values for other occurrences of the video coding type.

Referring now to FIG. 12, therein is shown a functional block diagram of the video coding system 100. The video coding system 100 can include the first device 102, the second device 104 and the communication path 106.

The first device 102 can communicate with the second device 104 over the communication path 106. The first device 102 can send information in a first device transmission 1232 over the communication path 106 to the second device 104. The second device 104 can send information in a second device transmission 1234 over the communication path 106 to the first device 102.

For illustrative purposes, the video coding system 100 is shown with the first device 102 as a client device, although it is understood that the video coding system 100 can have the first device 102 as a different type of device. For example, the first device can be a server. In a further example, the first device 102 can be the video encoder 103 of FIG. 1, the video decoder 105 of FIG. 1, or a combination thereof.

Also for illustrative purposes, the video coding system 100 is shown with the second device 104 as a server, although it is understood that the video coding system 100 can have the second device 104 as a different type of device. For example, the second device 104 can be a client device. In a further example, the second device 104 can be the video encoder 103, the video decoder 105, or a combination thereof.

For brevity of description in this embodiment of the present invention, the first device 102 will be described as a client device, such as a video camera, smart phone, or a combination thereof. The present invention is not limited to this selection for the type of devices. The selection is an example of the present invention.

The first device 102 can include a first control unit 1208. The first control unit 1208 can include a first control interface 1214. The first control unit 1208 can execute a first software 1212 to provide the intelligence of the video coding system 100.

The first control unit 1208 can be implemented in a number of different manners. For example, the first control unit 1208 can be a processor, an embedded processor, a microprocessor, a hardware control logic, a hardware finite state machine (FSM), a digital signal processor (DSP), or a combination thereof.

The first control interface 1214 can be used for communication between the first control unit 1208 and other functional units in the first device 102. The first control interface 1214 can also be used for communication that is external to the first device 102.

The first control interface 1214 can receive information from the other functional units or from external sources, or can transmit information to the other functional units or to external destinations. The external sources and the external destinations refer to sources and destinations external to the first device 102.

The first control interface 1214 can be implemented in different ways and can include different implementations depending on which functional units or external units are being interfaced with the first control interface 1214. For example, the first control interface 1214 can be implemented with electrical circuitry, microelectromechanical systems (MEMS), optical circuitry, wireless circuitry, wireline circuitry, or a combination thereof.

The first device 102 can include a first storage unit 1204. The first storage unit 1204 can store the first software 1212. The first storage unit 1204 can also store the relevant information, such as images, syntax information, video, maps, profiles, display preferences, sensor data, or any combination thereof.

The first storage unit 1204 can be a volatile memory, a nonvolatile memory, an internal memory, an external memory, or a combination thereof. For example, the first storage unit 1204 can be a nonvolatile storage such as non-volatile random access memory (NVRAM), Flash memory, disk storage, or a volatile storage such as static random access memory (SRAM).

The first storage unit 1204 can include a first storage interface 1218. The first storage interface 1218 can be used for communication between the first storage unit 1204 and other functional units in the first device 102. The first storage interface 1218 can also be used for communication that is external to the first device 102.

The first device 102 can include a first imaging unit 1206. The first imaging unit 1206 can capture the video content 108 of FIG. 1 from the real world. The first imaging unit 1206 can include a digital camera, an video camera, an optical sensor, or any combination thereof.

The first imaging unit 1206 can include a first imaging interface 1216. The first imaging interface 1216 can be used for communication between the first imaging unit 1206 and other functional units in the first device 102.

The first imaging interface 1216 can receive information from the other functional units or from external sources, or can transmit information to the other functional units or to external destinations. The external sources and the external destinations refer to sources and destinations external to the first device 102.

The first imaging interface 1216 can include different implementations depending on which functional units or external units are being interfaced with the first imaging unit 1206. The first imaging interface 1216 can be implemented with technologies and techniques similar to the implementation of the first control interface 1214.

The first storage interface 1218 can receive information from the other functional units or from external sources, or can transmit information to the other functional units or to external destinations. The external sources and the external destinations refer to sources and destinations external to the first device 102.

The first storage interface 1218 can include different implementations depending on which functional units or external units are being interfaced with the first storage unit 1204. The first storage interface 1218 can be implemented with technologies and techniques similar to the implementation of the first control interface 1214.

The first device 102 can include a first communication unit 1210. The first communication unit 1210 can be for enabling external communication to and from the first device 102. For example, the first communication unit 1210 can permit the first device 102 to communicate with the second device 104, an attachment, such as a peripheral device or a computer desktop, and the communication path 106.

The first communication unit 1210 can also function as a communication hub allowing the first device 102 to function as part of the communication path 106 and not limited to be an end point or terminal unit to the communication path 106. The first communication unit 1210 can include active and passive components, such as microelectronics or an antenna, for interaction with the communication path 106.

The first communication unit 1210 can include a first communication interface 1220. The first communication interface 1220 can be used for communication between the first communication unit 1210 and other functional units in the first device 102. The first communication interface 1220 can receive information from the other functional units or can transmit information to the other functional units.

The first communication interface 1220 can include different implementations depending on which functional units are being interfaced with the first communication unit 1210. The first communication interface 1220 can be implemented with technologies and techniques similar to the implementation of the first control interface 1214.

The first device 102 can include a first user interface 1202. The first user interface 1202 allows a user (not shown) to interface and interact with the first device 102. The first user interface 1202 can include a first user input (not shown). The first user input can include touch screen, gestures, motion detection, buttons, sliders, knobs, virtual buttons, voice recognition controls, or any combination thereof.

The first user interface 1202 can include the first display interface 120. The first display interface 120 can allow the user to interact with the first user interface 1202. The first display interface 120 can include a display, a video screen, a speaker, or any combination thereof.

The first control unit 1208 can operate with the first user interface 1202 to display video information generated by the video coding system 100 on the first display interface 120. The first control unit 1208 can also execute the first software 1212 for the other functions of the video coding system 100, including receiving video information from the first storage unit 1204 for display on the first display interface 120. The first control unit 1208 can further execute the first software 1212 for interaction with the communication path 106 via the first communication unit 1210.

For illustrative purposes, the first device 102 can be partitioned having the first user interface 1202, the first storage unit 1204, the first control unit 1208, and the first communication unit 1210, although it is understood that the first device 102 can have a different partition. For example, the first software 1212 can be partitioned differently such that some or all of its function can be in the first control unit 1208 and the first communication unit 1210. Also, the first device 102 can include other functional units not shown in FIG. 1 for clarity.

The video coding system 100 can include the second device 104. The second device 104 can be optimized for implementing the present invention in a multiple device embodiment with the first device 102. The second device 104 can provide the additional or higher performance processing power compared to the first device 102.

The second device 104 can include a second control unit 1248. The second control unit 1248 can include a second control interface 1254. The second control unit 1248 can execute a second software 1252 to provide the intelligence of the video coding system 100.

The second control unit 1248 can be implemented in a number of different manners. For example, the second control unit 1248 can be a processor, an embedded processor, a microprocessor, a hardware control logic, a hardware finite state machine (FSM), a digital signal processor (DSP), or a combination thereof.

The second control interface 1254 can be used for communication between the second control unit 1248 and other functional units in the second device 104. The second control interface 1254 can also be used for communication that is external to the second device 104.

The second control interface 1254 can receive information from the other functional units or from external sources, or can transmit information to the other functional units or to external destinations. The external sources and the external destinations refer to sources and destinations external to the second device 104.

The second control interface 1254 can be implemented in different ways and can include different implementations depending on which functional units or external units are being interfaced with the second control interface 1254. For example, the second control interface 1254 can be implemented with electrical circuitry, microelectromechanical systems (MEMS), optical circuitry, wireless circuitry, wireline circuitry, or a combination thereof.

The second device 104 can include a second storage unit 1244. The second storage unit 1244 can store the second software 1252. The second storage unit 1244 can also store the relevant information, such as images, syntax information, video, maps, profiles, display preferences, sensor data, or any combination thereof.

The second storage unit 1244 can be a volatile memory, a nonvolatile memory, an internal memory, an external memory, or a combination thereof. For example, the second storage unit 1244 can be a nonvolatile storage such as non-volatile random access memory (NVRAM), Flash memory, disk storage, or a volatile storage such as static random access memory (SRAM).

The second storage unit 1244 can include a second storage interface 1258. The second storage interface 1258 can be used for communication between the second storage unit 1244 and other functional units in the second device 104. The second storage interface 1258 can also be used for communication that is external to the second device 104.

The second storage interface 1258 can receive information from the other functional units or from external sources, or can transmit information to the other functional units or to external destinations. The external sources and the external destinations refer to sources and destinations external to the second device 104.

The second storage interface 1258 can include different implementations depending on which functional units or external units are being interfaced with the second storage unit 1244. The second storage interface 1258 can be implemented with technologies and techniques similar to the implementation of the second control interface 1254.

The second device 104 can include a second imaging unit 1246. The second imaging unit 1246 can capture the video content 108 from the real world. The first imaging unit 1206 can include a digital camera, an video camera, an optical sensor, or any combination thereof.

The second imaging unit 1246 can include a second imaging interface 1256. The second imaging interface 1256 can be used for communication between the second imaging unit 1246 and other functional units in the second device 104.

The second imaging interface 1256 can receive information from the other functional units or from external sources, or can transmit information to the other functional units or to external destinations. The external sources and the external destinations refer to sources and destinations external to the second device 104.

The second imaging interface 1256 can include different implementations depending on which functional units or external units are being interfaced with the second imaging unit 1246. The second imaging interface 1256 can be implemented with technologies and techniques similar to the implementation of the first control interface 1214.

The second device 104 can include a second communication unit 1250. The second communication unit 1250 can enable external communication to and from the second device 104. For example, the second communication unit 1250 can permit the second device 104 to communicate with the first device 102, an attachment, such as a peripheral device or a computer desktop, and the communication path 106.

The second communication unit 1250 can also function as a communication hub allowing the second device 104 to function as part of the communication path 106 and not limited to be an end point or terminal unit to the communication path 106. The second communication unit 1250 can include active and passive components, such as microelectronics or an antenna, for interaction with the communication path 106.

The second communication unit 1250 can include a second communication interface 1260. The second communication interface 1260 can be used for communication between the second communication unit 1250 and other functional units in the second device 104. The second communication interface 1260 can receive information from the other functional units or can transmit information to the other functional units.

The second communication interface 1260 can include different implementations depending on which functional units are being interfaced with the second communication unit 1250. The second communication interface 1260 can be implemented with technologies and techniques similar to the implementation of the second control interface 1254.

The second device 104 can include a second user interface 1242. The second user interface 1242 allows a user (not shown) to interface and interact with the second device 104. The second user interface 1242 can include a second user input (not shown). The second user input can include touch screen, gestures, motion detection, buttons, sliders, knobs, virtual buttons, voice recognition controls, or any combination thereof.

The second user interface 1242 can include a second display interface 120. The second display interface 120 can allow the user to interact with the second user interface 1242. The second display interface 120 can include a display, a video screen, a speaker, or any combination thereof.

The second control unit 1248 can operate with the second user interface 1242 to display information generated by the video coding system 100 on the second display interface 120. The second control unit 1248 can also execute the second software 1252 for the other functions of the video coding system 100, including receiving display information from the second storage unit 1244 for display on the second display interface 120. The second control unit 1248 can further execute the second software 1252 for interaction with the communication path 106 via the second communication unit 1250.

For illustrative purposes, the second device 104 can be partitioned having the second user interface 1242, the second storage unit 1244, the second control unit 1248, and the second communication unit 1250, although it is understood that the second device 104 can have a different partition. For example, the second software 1252 can be partitioned differently such that some or all of its function can be in the second control unit 1248 and the second communication unit 1250. Also, the second device 104 can include other functional units not shown in FIG. 1 for clarity.

The first communication unit 1210 can couple with the communication path 106 to send information to the second device 104 in the first device transmission 1232. The second device 104 can receive information in the second communication unit 1250 from the first device transmission 1232 of the communication path 106.

The second communication unit 1250 can couple with the communication path 106 to send video information to the first device 102 in the second device transmission 1234. The first device 102 can receive video information in the first communication unit 1210 from the second device transmission 1234 of the communication path 106. The video coding system 100 can be executed by the first control unit 1208, the second control unit 1248, or a combination thereof.

The functional units in the first device 102 can work individually and independently of the other functional units. For illustrative purposes, the video coding system 100 is described by operation of the first device 102. It is understood that the first device 102 can operate any of the modules and functions of the video coding system 100. For example, the first device 102 can be described to operate the first control unit 1208.

The functional units in the second device 104 can work individually and independently of the other functional units. For illustrative purposes, the video coding system 100 can be described by operation of the second device 104. It is understood that the second device 104 can operate any of the modules and functions of the video coding system 100. For example, the second device 104 is described to operate the second control unit 1248.

For illustrative purposes, the video coding system 100 is described by operation of the first device 102 and the second device 104. It is understood that the first device 102 and the second device 104 can operate any of the modules and functions of the video coding system 100. For example, the first device 102 is described to operate the first control unit 1208, although it is understood that the second device 104 can also operate the first control unit 1208.

Referring now to FIG. 13, therein is shown a control flow 1300 of the video coding system 100 of FIG. 1. The control flow 1300 describes decoding the video bitstream 110 of FIG. 1 by receiving the video bitstream 110, extracting the video syntax 114 of FIG. 1, decoding the video bitstream 110, and displaying the video stream 112 of FIG. 1.

The video coding system 100 can include a receive module 1302. The receive module 1302 can receive the video bitstream 110 encoded by the video encoder 103 of FIG. 1.

The video bitstream 110 can be received in a variety of ways. For example, the video bitstream 110 can be received from the video encoder 103 of FIG. 1 as a streaming serial bitstream, a pre-encoded video file (not shown), in a digital message (not shown) over the communication path 106 of FIG. 1, or a combination thereof.

In an illustrative example, the video bitstream 110 can be received as a serial bitstream in a timewise manner with each element of the video syntax 114 received sequentially. The video bitstream 110 can include the video syntax 114 such as the HEVC VUI syntax 402 of FIG. 4, the VUI first extension syntax 502 of FIG. 5, the VUI second extension syntax 602 of FIG. 6, the HRD syntax 302 of FIG. 3, or a combination thereof.

For example, the receive module 1302 can receive the HEVC VUI syntax 402 with the HRD parameters structure 448 of FIG. 4 received before the low delay HRD flag 340 of FIG. 3. Similarly, the NAL HRD parameters present flag 318 of FIG. 3 can be received before the HRD parameters structure 448. If the NAL HRD parameters present flag 318 has a value of 0, then the VCL HRD parameters present flag 320 of FIG. 3 can be received before the HRD parameters structure 448.

The video bitstream 110 can include one or more the extension layers 230 of FIG. 2 for representing the video content 108 of FIG. 1 at different frame rates. The receive module 1302 can selectively filter the extension layers 230 to reduce the size of the video bitstream 110.

For example, the receive module 1302 can receive the video bitstream 110 having the extension layers 230 for three different frame rates, such as 60 fps, 30 fps, and 15 fps. The receive module 1302 can filter the video bitstream 110 to remove the 60 fps and the 30 fps occurrences of the extension layers 230 and only process the 15 fps occurrence of the extension layers 230.

The video coding system 100 can include a get syntax module 1304. The get syntax module 1304 can identify and extract the video syntax 114 of the video bitstream 110.

The get syntax module 1304 can extract the video syntax 114 for the video bitstream 110 in a variety of ways. For example, the get syntax module 1304 can extract the video syntax 114 by searching the video bitstream 110 for headers indicating the presence of the video syntax 114. In another example, the video syntax 114 can be extracted from the video bitstream 110 using a demultiplexer (not shown) to separate the video syntax 114 from the video image data of the video bitstream 110.

In yet another example, the video syntax 114 can be extracted from the video bitstream 110 by extracting a sequence parameter set Raw Byte Sequence Payload (RBSP) syntax. The sequence parameter set RBSP is a syntax structure containing an integer number of bytes encapsulated in a network abstraction layer unit. The RBSP can be either empty or have the form of a string of data bits containing syntax elements followed by a RBSP stop bit and followed by zero or more addition bits equal to 0.

In an illustrative example, the video syntax 114 can be extracted from a serial bitstream in a timewise manner by extracting individual elements as the elements are available in time order in the video bitstream 110. The video coding system 100 can selectively extract and process later elements based on the values of the earlier extracted elements.

For example, the get syntax module 1304 can process the HRD syntax 302 based on the previously received value of the low delay HRD flag 340. The HEVC VUI syntax 402 includes the low delay HRD flag 340 positioned before the HRD syntax 302 in the serial transmission of the video bitstream 110. The low delay HRD flag 340 is extracted before the HRD syntax 302. The NAL HRD parameters present flag 318 and the VCL HRD parameters present flag 320 are extracted before the HRD syntax 302.

The elements of the HRD syntax 302 can be extracted based on the value of the low delay HRD flag 340, the NAL HRD parameters present flag 318, and the VCL HRD parameters present flag 320. For example, if the low delay HRD flag 340 has a value of 1 and either the NAL HRD parameters present flag 318 or the VCL HRD parameters present flag 320 has a value of 1, then the value of the CPB count 342 of FIG. 3 of the HRD syntax 302 can be extracted and expressly set to 0 by the get syntax module 1304 and the video coding system 100 can operating in a low delay mode with a single coded picture buffer.

In another example, the HEVC extension flag 442 of FIG. 4 can be extracted from the HEVC VUI syntax 402 in the video syntax 114 of the video bitstream 110. If the HEVC extension flag 442 has a value of 1, then the VUI extension layer structure 444 of FIG. 4 can be extracted from the video syntax 114, such as the HEVC VUI syntax 402. The VUI extension layer structure 444 can include the VUI dimension identification 514 of FIG. 5, such as the view order index, the depth flag, the dependency identification, the quality identification, or a combination thereof.

In a further example, the VUI extension layer structure 444 can be extracted from the video syntax 114 of the video bitstream 110 based on the HEVC extension flag 442 having a value of 1, indicating that the VUI extension layer structure 444 is present in the video bitstream 110. If the HEVC extension flag 442 has a value of 0, then the VUI extension layer structure 444 is not present in the video bitstream 110.

In yet another example, if the video bitstream 110 is received in a file, then the video syntax 114 can be detected by examining the file extension of the file containing the video bitstream 110. In yet another example, if the video bitstream 110 is received as a digital message over the communication path 106 of FIG. 1, then the video syntax 114 can be provided as a portion of the structure of the digital message.

It has been discovered that the get syntax module 1304 can increase performance by dynamically decoding the video bitstream 110 to process the HRD parameters structure 448 based on previously extracted occurrences of the low delay HRD flag 340. For example, receiving the low delay HRD flag 340 increases decoding performance by changing the level of delay allowed in the coded picture buffers when applying the HRD parameters structure 448.

It has been discovered that the get syntax module 1304 can increase performance by extracting the scalability dimension information from the scalability type table 702 of FIG. 7 using the VUI scalability type 508 of FIG. 5 as an index to look up the scalability dimension information. By extracting the scalability information from the pre-defined occurrence of the scalability type table 702, the get syntax module 1304 can reduce retrieval time and increase performance.

It has been discovered that the get syntax module 1304 can increase performance by extracting the scalability dimension information from the dimension type table 802 of FIG. 8 using the VUI dimension type 608 of FIG. 6 as an index to look up the VUI dimension identification 514 of FIG. 5. By extracting the VUI dimension identification 514 from the pre-defined occurrence of the dimension type table 802, the get syntax module 1304 can reduce retrieval time and increase performance.

It has been discovered that the get syntax module 1304 can increase performance by extracting the sub-scalability dimension information from the sub-scalability table 902 of FIG. 9 using the VUI sub-scalability type 516 of FIG. 5 as an index to look up the scalability dimension information. By extracting the sub-scalability dimension information from the pre-defined occurrence of the sub-scalability table 902, the get syntax module 1304 can reduce retrieval time and increase performance.

The get syntax module 1304 can extract the individual elements of the video syntax 114 based on the syntax type 202 of FIG. 2. The syntax type 202 can include AVC video, SVC video, MVC video, MVD video, SSV video, or a combination thereof.

The get syntax module 1304 can extract the video syntax 114 having video usability information. The video syntax 114 can include the HEVC VUI syntax 402, the HEVC VUI syntax 402, the HRD syntax 302, or a combination thereof.

The get syntax module 1304 can extract the video syntax 114 having hypothetical reference decoder information. The video syntax 114 can have a variety of configurations. For example, the HEVC VUI syntax 402 can include one occurrence of the HRD syntax 302 for all occurrences of the extension layers 230. In another example, the get syntax module 1304 can include one occurrence of the HRD syntax 302 for each occurrence of the extension layers 230.

In an illustrative example, the HRD syntax 302 can include single occurrences of the CPB count 342, the bit rate scale 326 of FIG. 3, the CPB size scale 328 of FIG. 3, the initial CPB removal delay length 330 of FIG. 3, the CPB removal delay length 332 of FIG. 3, and the DPB output delay length 334 of FIG. 3. The HRD syntax 302 can include a loop structure with occurrences for each of the fixed picture rate flag 336 of FIG. 3, the picture duration 338 of FIG. 3, the low delay HRD flag 340, the CPB count 342, and the HRD parameters sub-layer 344 of FIG. 3.

The video coding system 100 can include a decode module 1306. The decode module 1306 can decode the video bitstream 110 using the video syntax 114 to form the video stream 112. The decode module 1306 can include a get extension layers module 1308 and a decode extension layers module 1310.

The decode module 1306 can decode the video bitstream 110 using the video syntax 114, such as the HEVC VUI syntax 402, the VUI first extension syntax 502, the VUI second extension syntax 602, or a combination thereof. The decode module 1306 can identify and extract one of the extension layers 230 based on the VUI extension layer structure 444.

For example, one of the extension layers 230 can be extracted from the video bitstream 110 based on the VUI dimension type 608 of the VUI extension layer structure 444. The VUI dimension type 608 can indicate the VUI dimension identification 514 of the extension layer 230.

In another example, one of the extension layers 230 can be extracted from the video bitstream 110 based on the VUI scalability type 508. The VUI scalability type 508 can indicate the type of scalability represented in the video bitstream 110, such as spatial scalability, quality scalability, multiview scalability, depth scalability, or a combination thereof.

In yet another example, one of the extension layers 230 can be extracted from the video bitstream 110 based on the VUI sub-scalability type 516. The VUI sub-scalability type 516 can indicate the type of sub-scalability dimension of one of the extension layers 230 represented in the video bitstream 110, such as mono-view (2D), interlace (2D), frame-compatible (3D), stereo-view (3D), multi-view (3D), or a combination thereof.

The get extension layers module 1308 can identify the extension layers 230 to extract from the video bitstream 110 to form the video stream 112. The get extension layers module 1308 can identify the extension layers 230 in a variety of ways.

For example, the get extension layers module 1308 can identify the extension layers 230 by extracting the extension layer count 238 of FIG. 2 from the video syntax 114, such as HEVC VUI extension syntax. The extension layer count 238 indicates the total number of extension layers 230 in the video bitstream 110.

The get extension layers module 1308 can extract the extension layers 230 from the video bitstream 110 using the video syntax 114 to describe the data type and size of the elements of the video syntax 114. The video syntax 114 can include the hypothetical reference decoder parameters syntax, such as the HRD syntax 302.

For example, the get extension layers module 1308 can extract the aspect ratio flag 406 of FIG. 4 as an unsigned 1-bit value in the video bitstream 110. Similarly, the aspect ratio height 412 of FIG. 4 and the aspect ratio width 410 of FIG. 4 can be extracted from the video bitstream 110 as unsigned 16 bit values as described in the HEVC VUI syntax 402.

The get extension layers module 1308 can extract the extension layers 230 by parsing the data in the video bitstream 110 based on the video syntax 114. The video syntax 114 can define the number and configuration of the extension layers 230.

For example, the get extension layers module 1308 can use the extension layer count 238 to determine the total number of the extension layers 230 to extract from the video bitstream 110. The video format 420 of FIG. 4 can be extracted from the video bitstream 110 to determine the type of video system of the video content 108.

In another example, the CPB count 342 can be used to determine the number of coded picture buffers to be used to extract the extension layers 230. The bit rate scale 326 can be used to determine the maximum input bit rate for the coded picture buffers. The CPB size scale 328 can be used to determine the size of the coded picture buffers.

In an illustrative example, the get extension layers module 1308 can extract the first occurrence 232 of FIG. 2 and the second occurrence 234 of FIG. 2 of the extension layers 230 from the video bitstream 110 based on the HRD syntax 302. The HRD syntax 302 can be common for all of the extension layers 230 in the video bitstream 110.

The decode extension layers module 1310 can receive the extension layers 230 from the get extension layers module 1308 and decode the extension layers 230 to form the video stream 112. The decode extension layers module 1310 can decode the extension layers 230 using the HRD syntax 302 to extract the video coding layer information from the video bitstream 110. The decode extension layers module 1310 can decode the extension layers 230 and select a subset of the extension layers 230 to form the video stream 112.

The video coding system 100 can include a display module 1312. The display module 1312 can receive the video stream 112 from the decode module 1306 and display the video stream 112 on the display interface 120 of FIG. 1. The video stream 112 can include one or more occurrences of the extension layers 230

The physical transformation from the optical images of physical objects of the video content 108 to displaying the video stream 112 on the pixel elements of the display interface 120 of FIG. 1 results in physical changes to the pixel elements of the display interface 120 in the physical world, such as the change of electrical state the pixel element, is based on the operation of the video coding system 100. As the changes in the physical world occurs, such as the motion of the objects captured in the video content 108, the movement itself creates additional information, such as the updates to the video content 108, that are converted back into changes in the pixel elements of the display interface 120 for continued operation of the video coding system 100.

The first software 1212 of FIG. 10 of the first device 102 of FIG. 1 can include the video coding system 100. For example, the first software 1212 can include the receive module 1302, the get syntax module 1304, the decode module 1306, and the display module 1312.

The first control unit 1208 of FIG. 10 can execute the first software 1212 for the receive module 1302 to receive the video bitstream 110. The first control unit 1208 can execute the first software 1212 for the get syntax module 1304 to identify and extract the video syntax 114 from the video bitstream 110. The first control unit 1208 can execute the first software 1212 for the decode module 1306 to form the video stream 112. The first control unit 1208 can execute the first software 1212 for the display module 1312 to display the video stream 112.

The second software 1252 of FIG. 10 of the second device 104 of FIG. 1 can include the video coding system 100. For example, the second software 1252 can include the receive module 1302, the get syntax module 1304, and the decode module 1306.

The second control unit 1248 of FIG. 10 can execute the second software 1252 for the receive module 1302 to receive the video bitstream 110. The second control unit 1248 can execute the second software 1252 for the get syntax module 1304 to identify and extract the video syntax 114 from the video bitstream 110. The second control unit 1248 can execute the second software 1252 for the decode module 1306 to form the video stream 112 of FIG. 1. The second control unit 1248 can execute the second software for the display module 1312 to display the video stream 112.

The video coding system 100 can be partitioned between the first software 1212 and the second software 1252. For example, the second software 1252 can include the decode module 1306, and the display module 1312. The second control unit 1248 can execute modules partitioned on the second software 1252 as previously described.

In an illustrative example, the video coding system 100 can include the video encoder 103 on the first device 102 and the video decoder 105 of FIG. 1 on the second device 104. The video decoder 105 can include the display processor 118 of FIG. 1 and the display interface 120.

The first software 1212 can include the receive module 1302 and the get syntax module 1304. Depending on the size of the first storage unit 1204 of FIG. 10, the first software 1212 can include additional modules of the video coding system 100. The first control unit 1208 can execute the modules partitioned on the first software 1212 as previously described.

The first control unit 1208 can operate the first communication unit 1210 of FIG. 10 to send the video bitstream 110 to the second device 104. The first control unit 1208 can operate the first software 1212 to operate the first imaging unit 1206 of FIG. 10. The second communication unit 1250 of FIG. 10 can send the video stream 112 to the first device 102 over the communication path 106.

The video coding system 100 describes the module functions or order as an example. The modules can be partitioned differently. For example, the get syntax module 1304 and the decode module 1306 can be combined. Each of the modules can operate individually and independently of the other modules.

Furthermore, data generated in one module can be used by another module without being directly coupled to each other. For example, the decode module 1306 can receive the video bitstream 110 from the receive module 1302.

The modules can be implemented in a variety of ways. The receive module 1302, the get syntax module 1304, the decode module 1306, and the display module 1312 can be implemented in as hardware accelerators (not shown) within the first control unit 1208 or the second control unit 1248, or can be implemented in as hardware accelerators (not shown) in the first device 102 or the second device 104 outside of the first control unit 1208 or the second control unit 1248.

Referring now to FIG. 14, therein is shown a flow chart of a method 1400 of operation of the video coding system in a further embodiment of the present invention. The method 1400 includes: receiving a video bitstream in a block 1402; extracting a video syntax from the video bitstream in a block 1404; extracting a high efficiency video coding (HEVC) extension flag from the video syntax in a block 1406; extracting a video usability information (VUI) extension layer structure from the video syntax based on the HEVC extension flag in a block 1408; extracting an extension layer from the video bitstream based on the VUI extension layer structure in a block 1410; and forming a video stream based on the extension layer for displaying on a device in a block 1412.

It has been discovered that the present invention thus has numerous aspects. The present invention valuably supports and services the historical trend of reducing costs, simplifying systems, and increasing performance. These and other valuable aspects of the present invention consequently further the state of the technology to at least the next level.

Thus, it has been discovered that the video coding system of the present invention furnishes important and heretofore unknown and unavailable solutions, capabilities, and functional aspects for efficiently coding and decoding video content for high definition applications. The resulting processes and configurations are straightforward, cost-effective, uncomplicated, highly versatile and effective, can be surprisingly and unobviously implemented by adapting known technologies, and are thus readily suited for efficiently and economically manufacturing video coding devices fully compatible with conventional manufacturing processes and technologies. The resulting processes and configurations are straightforward, cost-effective, uncomplicated, highly versatile, accurate, sensitive, and effective, and can be implemented by adapting known components for ready, efficient, and economical manufacturing, application, and utilization.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A method of operation of a video coding system comprising:
receiving a video bitstream;
extracting a video syntax from the video bitstream;
extracting a high efficiency video coding (HEVC) extension flag from the video syntax;
extracting a video usability information (VUI) extension layer structure from the video syntax based on the HEVC extension flag;
extracting an extension layer from the video bitstream based on the VUI extension layer structure; and
forming a video stream based on the extension layer for displaying on a device.

2. The method as claimed in claim 1 wherein forming the video stream includes forming the video stream for a resolution greater than or equal to 3840 pixels by 2160 pixels.

3. The method as claimed in claim 1 wherein extracting the VUI extension layer structure includes:
extracting the VUI scalability type for each occurrence of the extension layer; and
extracting the extension layer based on the VUI scalability type.

4. The method as claimed in claim 1 wherein extracting the VUI extension layer structure includes:
extracting the VUI dimension identification for each occurrence of the extension layer; and
extracting the extension layer based on the VUI dimension identification.

5. The method as claimed in claim 1 wherein extracting the VUI extension layer structure includes:
extracting the VUI sub-scalability type for each occurrence of the extension layer; and
extracting the extension layer based on the VUI sub-scalability type.

6. A method of operation a video coding system comprising:
receiving a video bitstream as a serial bitstream;
extracting a syntax type of the video content from the video bitstream;
extracting a video syntax from the video bitstream for the syntax type;
extracting a high efficiency video coding (HEVC) extension flag from the video syntax;
extracting a video usability information (VUI) extension layer structure from the video syntax based on the HEVC extension flag;
extracting an extension layer from the video bitstream based on the VUI extension layer structure; and
forming a video stream based on the extension layer and for displaying on a device.

7. The method as claimed in claim 6 wherein forming the video stream includes forming the video stream for a resolution greater than or equal to 7680 pixels by 4320 pixels.

8. The method as claimed in claim 6 wherein extracting the VUI extension layer structure includes:
extracting the VUI scalability type for each occurrence of the extension layer; and
extracting the extension layer based on the VUI scalability type.

9. The method as claimed in claim 6 wherein extracting the VUI extension layer structure includes:
extracting the VUI dimension identification for each occurrence of the extension layer; and
extracting the extension layer based on the VUI dimension identification.

10. The method as claimed in claim 6 wherein extracting the VUI extension layer structure includes:
extracting the VUI sub-scalability type for each occurrence of the extension layer; and
extracting the extension layer based on the VUI sub-scalability type.

11. A video coding system comprising:
a receive module for receiving a video bitstream as a serial bitstream;
a get syntax module, coupled to the receive module, for extracting a video syntax from the video bitstream, extracting a high efficiency video coding (HEVC) extension flag from the video syntax, and extracting a video usability information (VUI) extension layer structure from the video syntax based on the HEVC extension flag;
a decode module, coupled to the get syntax module, for extracting an extension layer from the video bitstream based on the VUI extension layer structure; and
a display module, coupled to the decode module, forming a video stream based on the extension layer for displaying on a device.

12. The system as claimed in claim 11 wherein the decode module is for forming the video stream for a resolution greater than or equal to 3840 pixels by 2160 pixels.

13. The system as claimed in claim 11 wherein:
the get syntax module is for extracting the VUI scalability type for each occurrence of the extension layer; and
the decode module is for extracting the extension layer based on the VUI scalability type.

14. The system as claimed in claim 11 wherein:
the get syntax module is for extracting the VUI dimension identification for each occurrence of the extension layer; and
the decode module is for extracting the extension layer based on the VUI dimension identification.

15. The system as claimed in claim 11 wherein:
the get syntax module is for extracting the VUI sub-scalability type for each occurrence of the extension layer; and
the decode module is for extracting the extension layer based on the VUI sub-scalability type.

16. The system as claimed in claim 11 wherein:
the get syntax module is for extracting a syntax type of the video content from the video bitstream; and
the get syntax module is for extracting a video syntax from the video bitstream for the syntax type.

17. The system as claimed in claim 16 wherein the decode module is for forming the video stream includes forming the video stream for a resolution greater than or equal to 7680 pixels by 4320 pixels.

18. The system as claimed in claim 16 wherein:
the get syntax module is for extracting the VUI scalability type for each occurrence of the extension layer; and
the decode module is for extracting the extension layer based on the VUI scalability type.

19. The system as claimed in claim 16 wherein:
the get syntax module is for extracting the VUI dimension identification for each occurrence of the extension layer; and
the decode module is for extracting the extension layer based on the VUI dimension identification.

20. The system as claimed in claim 16 wherein:
the get syntax module is for extracting the VUI sub-scalability type for each occurrence of the extension layer; and
the decode module is for extracting the extension layer based on the VUI sub-scalability type.
